(19) United States
(12) Patent Application Publication
(10) Pub. No.: US 2015/0052791 A1
(43) Pub. Date: Feb. 26, 2015

(54) ELECTRIC FIREPLACE ABLE TO SHOW 3D FLAME

(71) Applicant: Wei Lin Lu, Dong Guan City (CN)

(72) Inventor: Wei Lin Lu, Dong Guan City (CN)

(21) Appl. No.: 13/974,047

(22) Filed: Aug. 23, 2013

(51) Int. Cl. F21S 10/04

(52) U.S. Cl. CPC F21S 10/04
USPC 40/428

(57) ABSTRACT

An electric fireplace able to show 3D flame includes a housing, an image screen, a flame processing device, a light processing device and a 3D flame image plate carved with a flame pattern. The 3D flame image plate is located in back of the image screen. The light processing device is located in back of the 3D flame image plate. The 3D flame image plate includes a base, a fence and a protection layer. The fence is sandwiched between the base and the protection layer. The base is close to the image screen. The protection layer is close to the light processing device. The light processing device makes the light from the first light source dynamic to provide a 3D flame effect to the 3D flame image plate.

### BACKGROUND OF THE INVENTION

1. Field of the Invention

The present invention relates to an electric fireplace, and more particularly to an electric fireplace able to show 3D flame.

2. Description of the Prior Art

In the early days, a fireplace can be used for lighting, warming, baking. With the development of economy and technology, the three functions of lighting, warming, baking are gradually improved and separated. These days, a fireplace becomes warming equipment.

With the development of times, fireplaces are improved from the traditional fireplaces, such as wood burning fireplaces, fuel gas fireplaces or charcoal fireplaces, to electric fireplaces. The electric fireplaces come from the European classical fireplaces to cooperate with acoustics and optics technique to make a great change is for the traditional fireplaces. The electric fireplaces are green and friendly-environmental and provide a realistic burning effect.

In these days, electric fireplaces are rapidly developed to substitute the traditional fireplaces. However, the flame, the imitation charcoal and the lighting of the existing electric fireplaces cannot be changed, and they are unable to provide a realistic 3D flame effect. Accordingly, the inventor of the present invention has devoted himself based on his many years of practical experiences to solve this problem.

### SUMMARY OF THE INVENTION

The primary object of the present invention is to provide an electric fireplace able to show 3D flame to overcome the shortcomings of the existing electric fireplaces and to provide realistic flame.

In order to achieve the aforesaid object, the electric fireplace able to show 3D flame comprises a housing, an image screen, a flame processing device, a light processing device and a 3D flame image plate carved with a flame pattern. The image screen, the flame processing device, the light processing device and the 3D flame image plate are disposed in the housing. The flame processing device is located in front of the image screen. The 3D flame image plate is located in back of the image screen. The light processing device is located in back of the 3D flame image plate. A first light source is provided to cooperate with the light processing device. The 3D flame image plate comprises a base, a fence formed by printing ink and a protection layer partially pervious to light. The fence is sandwiched between the base and the protection layer. The base is close to the image screen. The protection layer is close to the light processing device.

Preferably, the protection layer is an epoxy layer, a plastic layer or a soft attachment layer.

Preferably, the epoxy layer, the plastic layer or the soft attachment layer has a frosted surface.

Alternatively, the epoxy layer, the plastic layer or the soft attachment layer has a printing ink surface.

Preferably, the 3D flame image plate is a flat plate or a curved plate.

Preferably, the 3D flame image plate is a soft plate or a hard plate.

Preferably, the flame processing device comprises an imitational charcoal and a second light source for radiation of the imitation charcoal. The second light source is located under the imitation charcoal.

Preferably, the light processing device comprises a light reflection assembly and a motor. The motor drives the light reflection assembly to rotate. The first light source is located under the light reflection assembly.

Preferably, the front of the housing is covered with a tempered glass or a meshed door. The tempered glass or the meshed door is located in front of the flame processing device.

Compared to the prior art, the advantages and effects of the present invention are that the fence formed by printing ink cooperates with the 3D flame image plate composed of the base, the fence and the protection layer and that the light processing device makes the light from the first light source dynamic to provide a 3D flame effect to the 3D flame image plate. People can see the 3D flame from all angles in front of the housing. The flame looks more realistic to improve the conventional electric fireplaces.

### BRIEF DESCRIPTION OF THE DRAWINGS

FIG. 1 is a partial perspective view according to a preferred embodiment of the present invention;

FIG. 2 is a sectional view according to the preferred embodiment of the present invention; and

FIG. 3 is an enlarged view showing the 3D flame image plate according to the preferred embodiment of the present invention.

### DETAILED DESCRIPTION OF THE PREFERRED EMBODIMENTS

Embodiments of the present invention will now be described, by way of example only, with reference to the accompanying drawings.

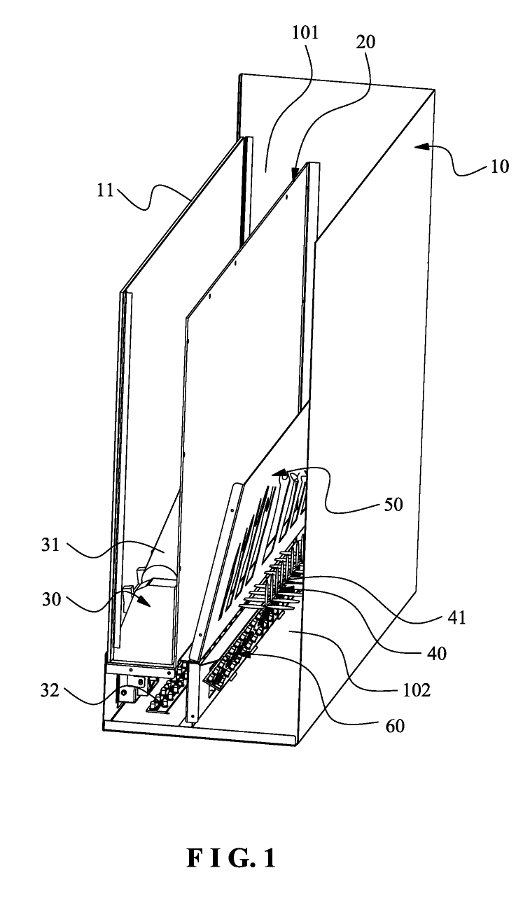

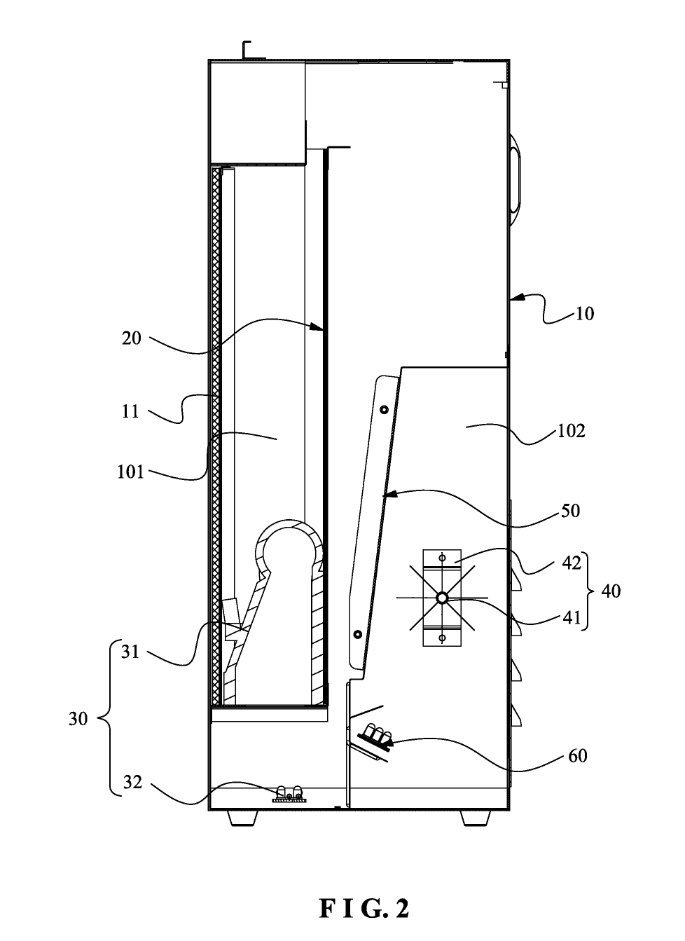

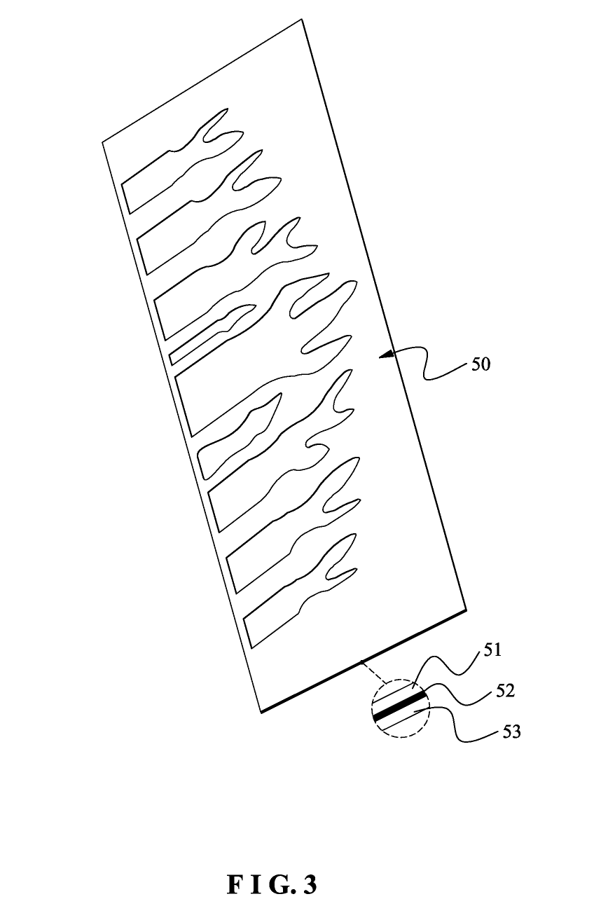

As shown in FIG. 1 to FIG. 3, the electric fireplace able to show 3D flame according to a preferred embodiment of the present invention comprises a housing 10, an image screen 20, a flame processing device 30, a light processing device 40 and a 3D flame image plate 50 carved with a flame pattern. The image screen 20, the flame processing device 30, the light processing device 40 and the 3D flame image plate 50 are disposed in the housing 10.

The housing 10 has a rectangular shape. The front of the housing 10 is covered with a tempered glass or a meshed door 11. The tempered glass or the meshed door 11 is located in front of the flame processing device 30. The flame processing device 30 can be seen through the tempered glass or the meshed door 11.

The flame processing device 30 is located in front of the image screen 20. Furthermore, the flame processing device 30 is located in a first accommodation space 101 defined between the image screen 20 and the inner wall of the housing 10. The 3D flame image plate 50 is located in back of the image screen 20. The light processing device 40 is located in back of the 3D flame image plate 50. A first light source 60 is provided to cooperate with the light processing device 40. Both the first light source 60 and the light processing device 40 are located in a second accommodation space 102 defined between the 3D flame image plate 50 and the inner wall of the housing 10. The color of the first light source 60 is warm white or yellow to radiate red, yellow, green, blue or colorful light, but not limited. In this embodiment, the flame processing device 30 comprises an imitational charcoal 31 and a second light source 32 for radiation of the imitation charcoal 31. The second light source 32 is located under the imitation charcoal 31. The light processing device 40 comprises a light reflection assembly 41 and a motor 42. The motor 42 drives the light reflection assembly 41 to rotate. The first light source 60 is located under the light reflection assembly 41.

The 3D flame image plate 50 is a flat plate or a curved plate. The 3D flame image plate 50 can be a soft plate or a hard plate, but not limited. In an embodiment, the 3D flame image plate 50 comprises a base 51, a fence 52 formed by printing ink, a protection layer 53 partially pervious to light. The fence 52 is sandwiched between the base 51 and the protection layer 53. The base 51 is close to the image screen 20, and the protection layer 53 is close to the light processing device 40. The protection layer 53 is an epoxy layer, a plastic layer or a soft attachment layer. Preferably, the epoxy layer, the plastic layer or the soft attachment layer has a frosted surface. Alternatively, the epoxy layer, the plastic layer or the soft attachment layer has a printing ink surface. In this way, the protection layer 53 is not completely pervious to light, partially pervious to light.

The working principle of this embodiment of the present invention is as follows:

When in use, the light from the first light source 60 shines on the light reflection assembly 41. The motor 42 drives the light reflection assembly 41 to rotate to provide a dynamic effect for the light. The dynamic light is reflected to the flame processing device 30 to form flame. After that, the light is reflected to the 3D flame image plate 50 to form a 3D flame pattern, such that the user can see the realistic 3D flame at the front of the housing 10 of the electric fireplace.

The feature of the present invention is that the fence formed by printing ink cooperates with the 3D flame image plate composed of the base, the fence and the protection layer and that the light processing device makes the light from the first light source dynamic to provide a 3D flame effect to the 3D flame image plate. People can see the 3D flame from all angles in front of the housing. The flame looks more realistic to improve the conventional electric fireplaces.

Although particular embodiments of the present invention have been described in detail for purposes of illustration, various modifications and enhancements may be made without departing from the spirit and scope of the present invention. Accordingly, the present invention is not to be limited except as by the appended claims.

1. An electric fireplace able to show 3D flame, comprising
a housing,
an image screen,
a flame processing device,
a light processing device and
a 3D flame image plate carved with a flame pattern,
the image screen, the flame processing device, the light processing device and the 3D flame image plate being disposed in the housing;
the flame processing device being located in front of the image screen,
the 3D flame image plate being located in back of the image screen, vertically extended downwards with a first light source disposed thereon, and to segregate the first light source from a second light source,
the light processing device being located in back of the 3D flame image plate,
the first light source being provided to cooperate with the light processing device; the 3D flame image plate comprising a base, a fence formed by printing ink and a protection layer partially pervious to light,
the fence being sandwiched between the base and the protection layer, the base being close to the image screen, and the protection layer being close to the light processing device, wherein the image screen and the 3D flame image plate are disjoint from each other to form a space extending downwards in communication to the second light source.

2. The electric fireplace able to show 3D flame as claimed in claim 1, wherein the protection layer is one of an epoxy layer, a plastic layer and a soft layer.

3. The electric fireplace able to show 3D flame as claimed in claim 2, wherein the epoxy layer, the plastic layer or the soft attachment layer has a frosted surface.

4. The electric fireplace able to show 3D flame as claimed in claim 2, wherein the epoxy layer, the plastic layer or the soft attachment layer has a printing ink surface.

5. The electric fireplace able to show 3D flame as claimed in claim 1, wherein the 3D flame image plate is one of a flat plate and a curved plate.

6. The electric fireplace able to show 3D flame as claimed in claim 1, wherein the 3D flame image plate is one of a soft plate and a hard plate.

7. The electric fireplace able to show 3D flame as claimed in claim 1, wherein the flame processing device comprises an imitational charcoal and the second light source for radiation of the imitation charcoal, the second light source being located under the imitation charcoal.

8. The electric fireplace able to show 3D flame as claimed in claim 1, wherein the light processing device comprises a light reflection assembly and a motor, the motor driving the light reflection assembly to rotate, the first light source being located under the light reflection assembly.

9. The electric fireplace able to show 3D flame as claimed in claim 1, wherein the front of the housing is covered with a tempered glass or a meshed door, the tempered glass or the meshed door being located in front of the flame processing device.
